(19) United States
(12) Patent Application Publication
(10) Pub. No.: US 2017/0080740 A1
(43) Pub. Date: Mar. 23, 2017

(54) TAB BOOKLET AND METHOD OF MAKING THE SAME

(71) Applicant: Simply Skilled in Second LLC, Pleasantville, NY (US)

(72) Inventor: Anna DiGilio, Pleasantville, NY (US)

(21) Appl. No.: 14/861,592

(22) Filed: Sep. 22, 2015

(51) Int. Cl. B42D 1/00; B42D 1/06

(52) U.S. Cl. CPC B42D 1/006; B42D 1/06

(57) ABSTRACT

A booklet, in the form of a tab booklet, includes a cover and a reading passage page that has a first portion in which first content is contained and a side tab that extends outwardly along a first side edge. The reading passage page includes a fold line that defines a top portion and a bottom portion of the reading passage page. The booklet includes a plurality of tabbed pages located subsequent to the reading passage page. Each tabbed page includes a tab formed along a top edge of the tabbed page, wherein the tabs of the tabbed pages are laterally offset from one another when the booklet is constructed. The fold line is located such that when the top portion is folded along the fold line and is superimposed over the bottom portion, the tabs are visible and extend above the folded reading passage page. The booklet is fastened along a left side edge of the cover and the left side edges of the tabbed pages and along a left side edge of the tab portion.

### TECHNICAL FIELD

The present invention relates to books and booklets and in particular relates to a tab booklet and a method of making the same.

### BACKGROUND

Books have been marketed for many years with a basically standard format: the edges of all the pages within a book line up with each other on three sides and are bound together in some fashion on the fourth side. This format is utilized easily by most adults and teenagers; however, very young children and other people with various physical disabilities may find it very difficult to flip from one page to the next. As a result for younger readers, it can be difficult to grasp and flip just one page at a time since all the page edges are lined up. Additionally, paper pages can have a tendency to stick to each other, thus causing further difficulties. One type of book that is popular with younger children is a flap book in which one or more pages includes a flap that can be opened to reveal additional contents, such as a picture or words. In addition, children enjoy arts and crafts projects and therefore, it would be desirable to provide a book or booklet that can be easily constructed by a younger reader and can be easily read by flipping the pages, etc.

### SUMMARY

A booklet, in the form of a tab booklet, includes a cover and a reading passage page that has a first portion in which first content is contained and a side tab that extends outwardly along a first side edge. The reading passage page includes a fold line that defines a top portion and a bottom portion of the reading passage page. The booklet includes a plurality of tabbed pages located subsequent to the reading passage page. Each tabbed page includes a tab formed along a top edge of the tabbed page, wherein the tabs of the tabbed pages are laterally offset from one another when the booklet is constructed.

The fold line is located such that when the top portion is folded along the fold line and is superimposed over the bottom portion, the tabs are visible and extend above the folded reading passage page. The booklet is fastened along a left side edge of the cover and the left side edges of the tabbed pages and along a left side edge of the tab portion.

### BRIEF DESCRIPTION OF THE DRAWING FIGURES

FIG. 1 is a front view of a base booklet used to construct the tab booklet according to the present invention;

FIG. 2 is a front surface (face) of a reading passage page that is part of the tab booklet;

FIG. 3 is a rear surface (face) of the reading passage page;

FIG. 4 is a page of the base booklet that includes a front cover;

FIG. 5 is a page of the base booklet that includes a pair of tabbed pages;

FIG. 6 is another page of the base booklet that includes a pair of tabbed pages;

FIG. 7 is a front view of the tab booklet in an assembled condition;

FIG. 8 is a front view of the tab booklet in an open condition showing the foldable reading passage page in a closed condition; and

FIG. 9 is a front view of the tab booklet in an open condition showing the foldable reading passage page in an open condition.

### DETAILED DESCRIPTION OF CERTAIN EMBODIMENTS

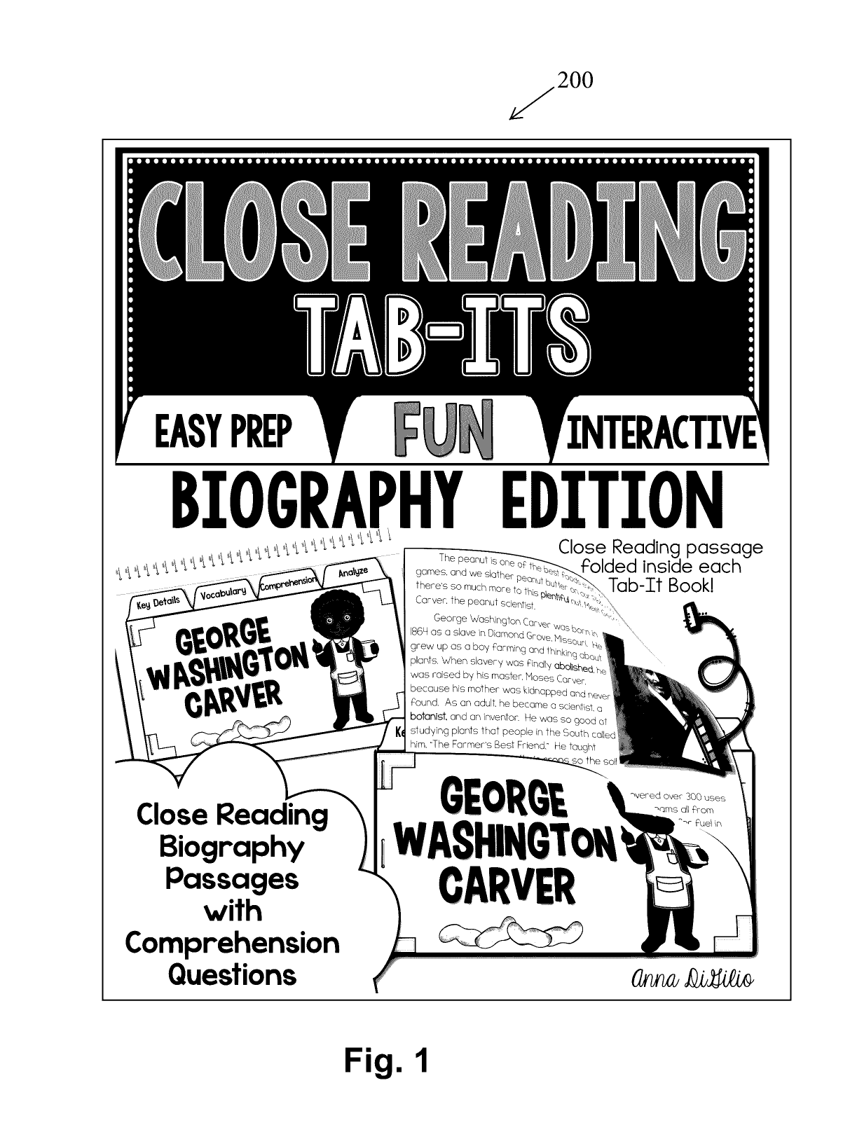

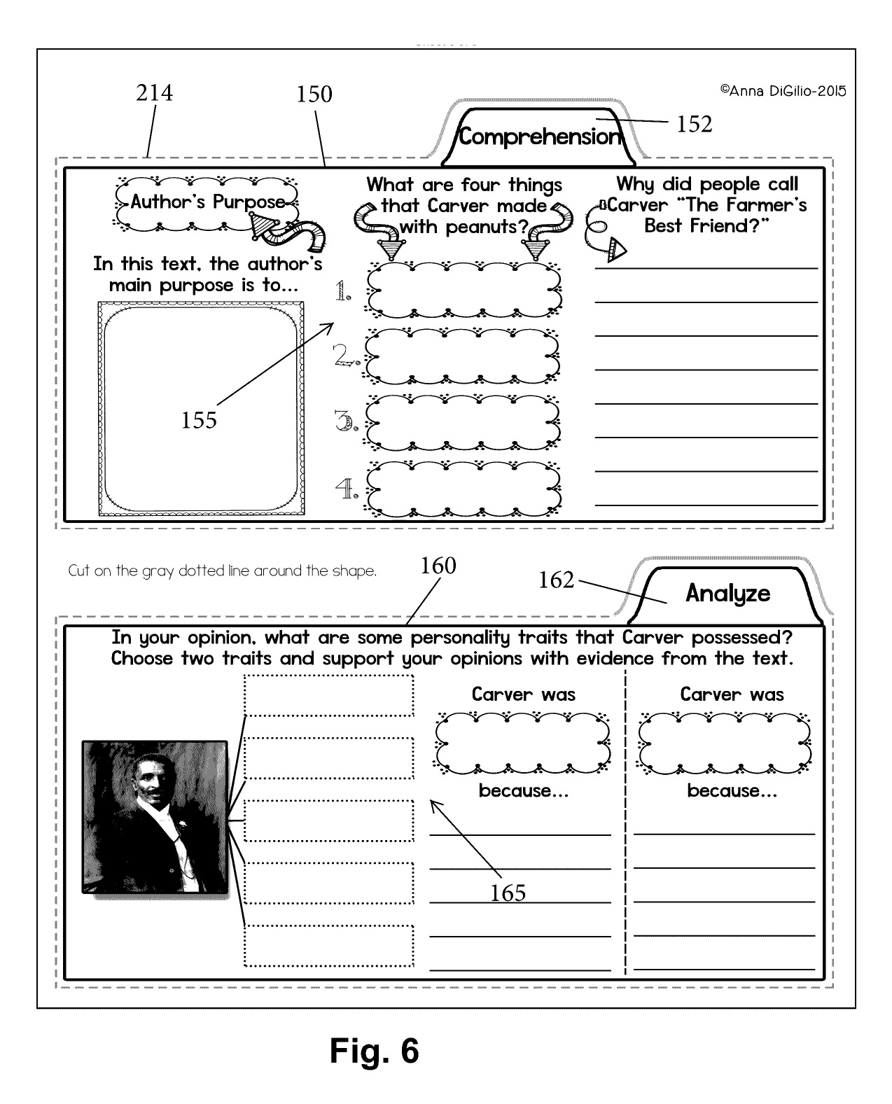

The present invention is directed to a tab book or booklet 100 (FIG. 6) that is constructed from a base booklet or pamphlet 200 (FIG. 1). In other words, the tab booklet 100 is created from the base booklet 200 which can act as instruction manual and provides step by step instructions for making the tab booklet 100.

The content of the tab booklet 100 can vary tremendously and because of the size and nature of the booklet, it is particularly suited for young school children. As will be discussed below, the tab booklet 100 not only includes written content (educational content) but also can include one or more interactive pages that allow the reader (child) to color in fun coloring page(s) and to write passages and answer questions, etc., as the child reflects on what he or she just read. The tab booklet 100 is thus a tool for increasing reading comprehension and is generally a fun educational tool.

The tab booklet 100 can be formed to have any number of different sizes. For example, in one embodiment, the tab booklet 100 is configured to be inserted and held within a conventional spiral-bound or black and white composition interactive notebook. The base booklet 200 from which the tab booklet 100 is created has a larger footprint compared to the tab booklet 100. For example, the base booklet 200 can be formed of letter sized paper (8.5×11 inches).

In the illustrated embodiment, the tab booklet 100 is part of a biography educational series in which a biography of a selected person is presented to the reader. For example, the illustrated biography is of George Washington Carver.

A number of pages of the base booklet 200 can be directed to instructions on how to print and assemble the tab booklet 100.

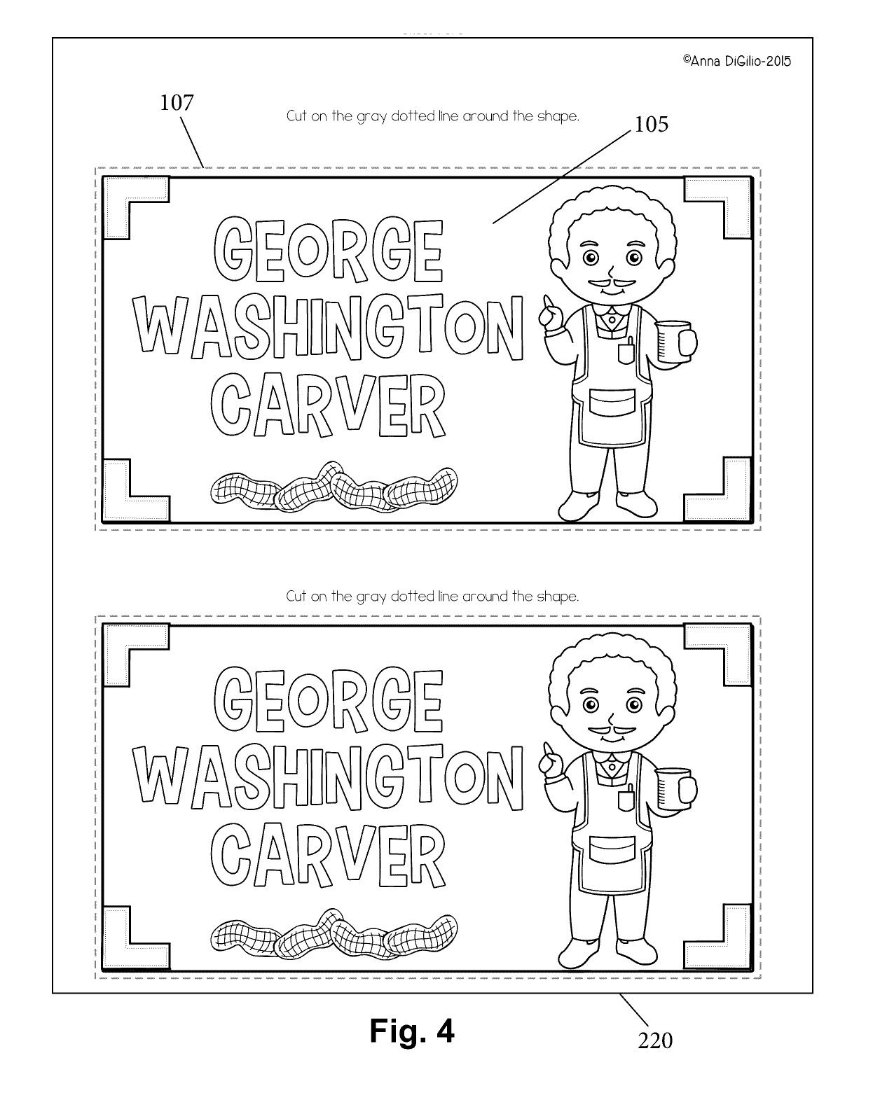

The base booklet 200 can include a cover page 220 (FIG. 4) in which a cover 105 for the tab booklet 100 is provided. The cover 105 can be created by cutting along the dotted line 107. More than one cover 105 can be provided on cover page 220 to allow the user to choose between covers or as shown, duplicate cover pages 220 can be provided to allow the child to decorate both cover pages 220 and then pick his or her favorite.

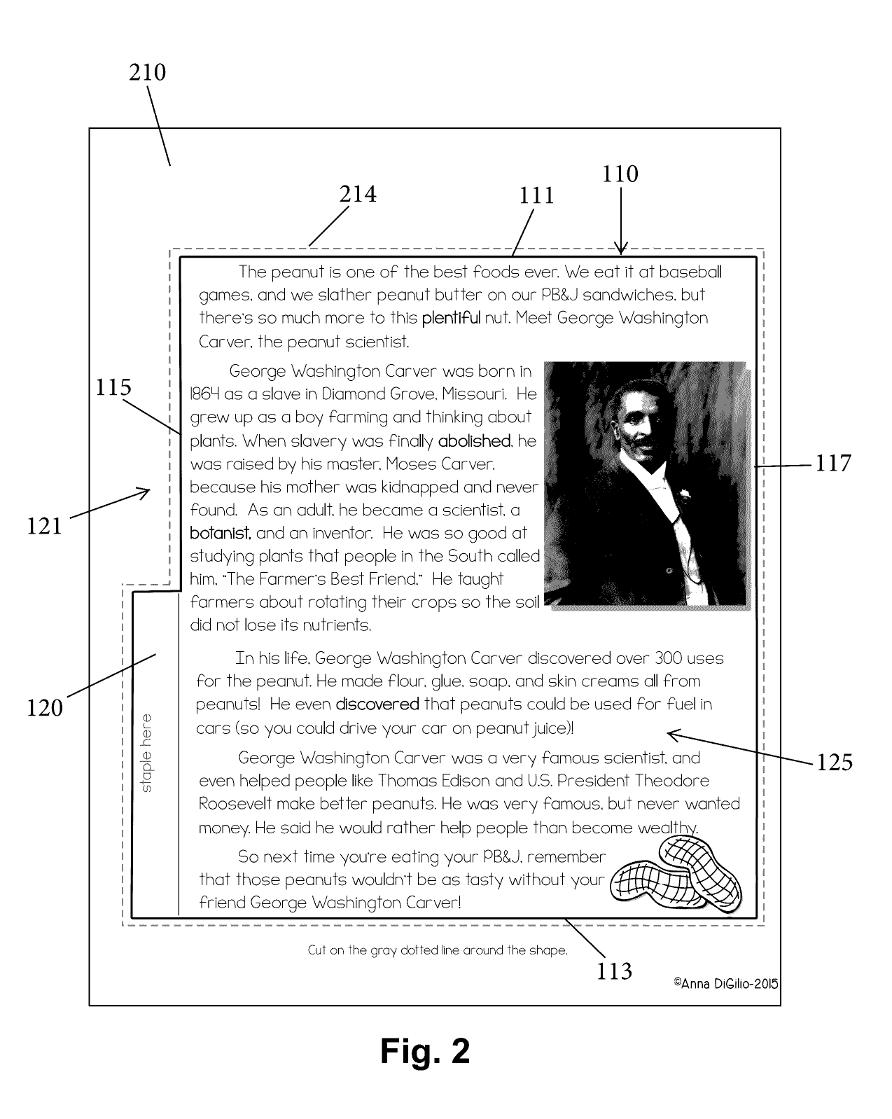

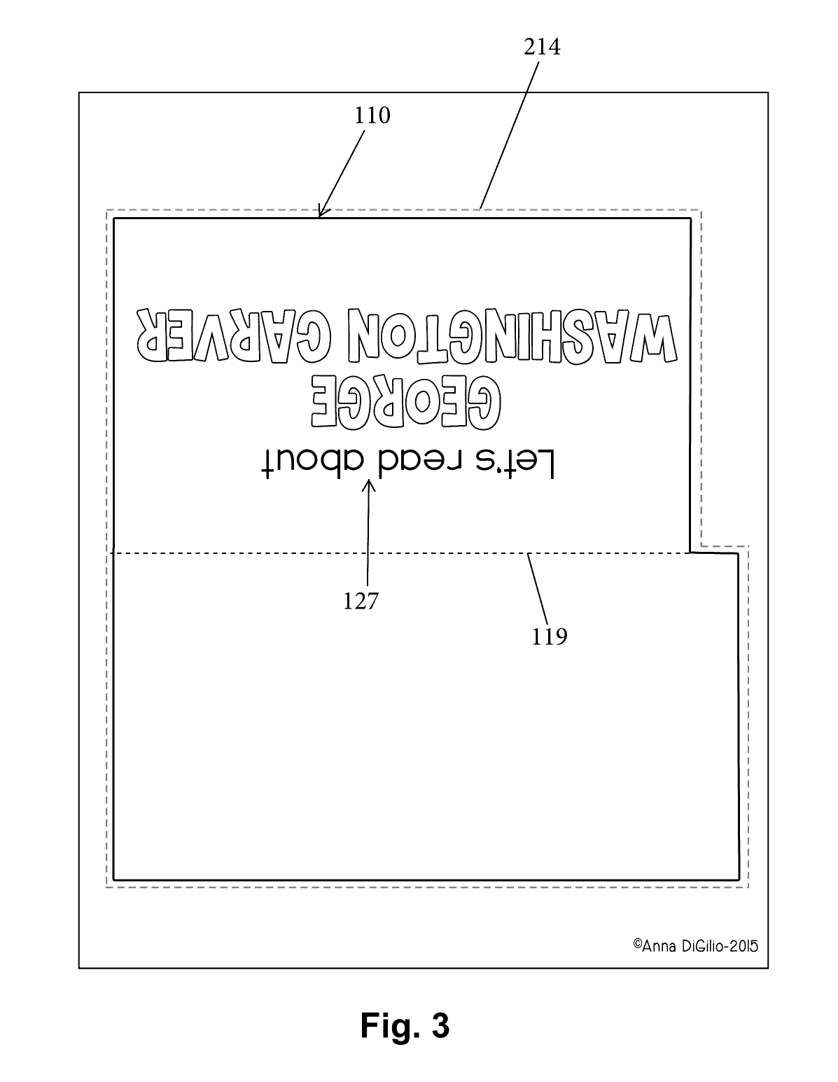

The base booklet 200 can include a reading passage page 210 which has a front side (FIG. 2) and an opposing rear side (FIG. 3). A dotted line 214 defines the boundary of a reading passage page 110 that is for inclusion in the tab booklet 100. The dotted line 214 thus represents a cutting line and once the user cuts completely along the continuous dotted line 214, the reading passage page 110 is generated and is sized to be included in the tab booklet 100. The reading passage page 110 has a first edge 111, an opposite second edge 113, a third edge 115 and an opposing fourth edge 117. As shown in FIGS. 2-3, the reading passage page 110 is not uniform in that the third edge 115 includes an enlarged tab 120 which extends outward relative to the remaining portion of the third edge 115 and thus can be in the form of a side tab. As a result of the formation of the tab 120, the width of the reading passage page 110 is greatest in the area in which the tab 120 is formed.

The size of the tab 120 can vary depending on the overall size of the tab booklet 100. However, in one embodiment, the length of the tab 120 is about equal to the length of the adjacent non-tabbed area 121 of the third edge 115.

The front side of the reading passage page 110 includes written text and/or graphics 125 (photographs, drawings, etc.) concerning the subject of the tab booklet 100. The text and graphics 125 are oriented from the first edge (top edge) 111 to the second edge (bottom edge) 113.

The rear side of the reading passage page 110 can also include text and/or graphics 127; however, this text/graphics 127 are located preferably on one half (i.e., the top half) of the reading passage page 110. The text/graphics 127 are also printed upside down since this text/graphics 127 are meant to be viewed when the top half of the reading passage page 110 is folded over as explained herein. In the illustrated embodiment, the text 127 reads as follows: “Let's read about George Washington Carver.”

Within the tab 120, text can be provided to assist the user in constructing the tab booklet 100. For example, the tab 120 can include text such as “staple here” to identify to the user that this area of the reading passage page 110 is meant to be attached to other pages to construct the booklet 100.

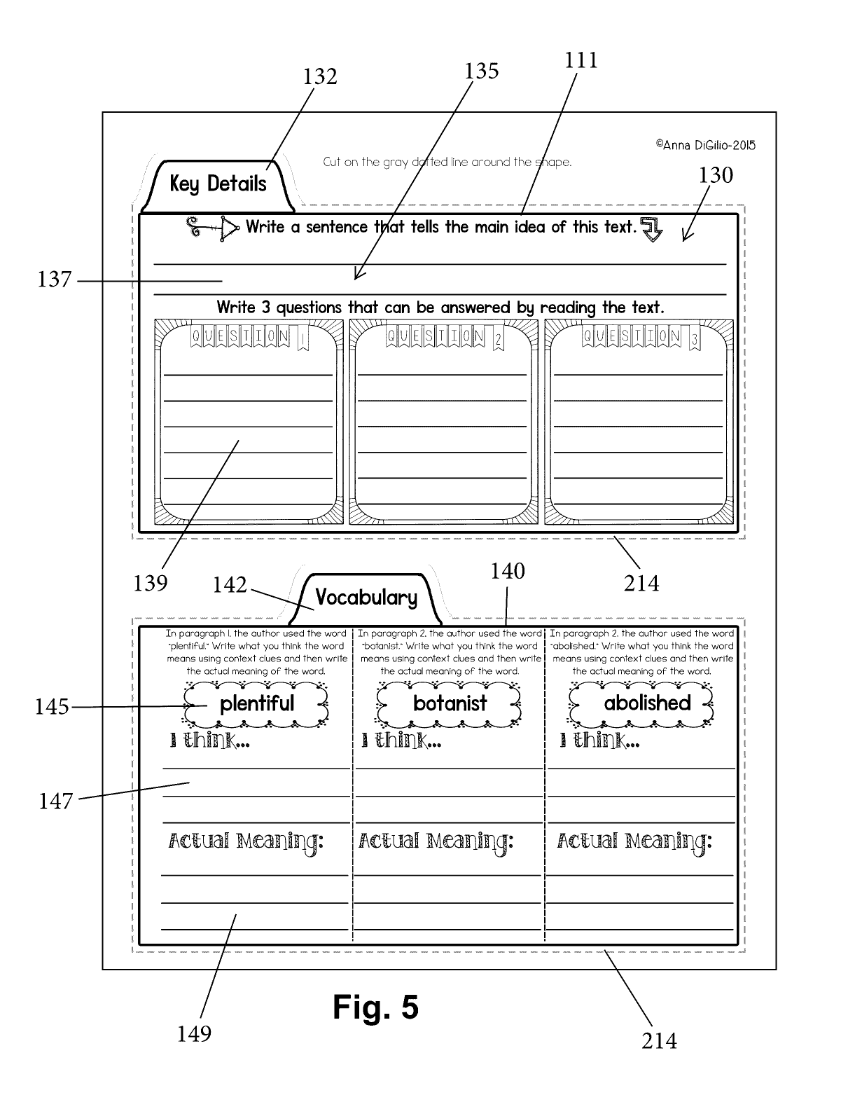

Subsequent pages to the reading passage page 110 can be in the form of tab pages in that a top edge of each respective page includes a tab with text identifying the nature of each respective page. For example, as shown in FIG. 5, one of the subsequent pages can be a “Key Details” page 130 that has a first tab 132 in a first location along a top edge 111 of page 130. The first tab 132 is of sufficient size to include the text “Key Details” and be clearly visible to the user and protrude sufficiently such that the user can immediately access the page 130 by locating the first tab 132 and then opening the booklet 100 to the first tab page location. Below the first tab 132, the page 130 has an area 135 for presenting information to the reader. In the case of the “Key Details” first page 130, the area 135 can contain one section 137 that allows the reader to write a sentence that tells the main idea of the text 115. In addition, another section 139, allows the reader to write three (3) facts/details that support the main idea of the text 115.

Another of the subsequent pages can be a “Vocabulary” page 140 (FIG. 5) that has a second tab 142 in a second location along the top edge 111 of page 140. The second tab 142 is of sufficient size to include the text “Vocabulary” and be clearly visible to the user and protrude sufficiently such that the user can immediately access the page 140 by locating the second tab 142 and then opening the booklet 100 to the second tab page location. Below the second tab 142, the page 140 has a first area 145 for presenting a number of words to the reader that were used in the reading passage 110. The reader is then asked to write down in a second area 147 what the reader believes that the word means and a third area 149 for the reader to write down the actual meaning of the word. In the illustrated embodiment, there are three words presented to the reader.

As with the other pages, the pages 130, 140 are formed by cutting along the dotted lines 214 of the page of the base booklet 200.

Another of the subsequent pages of the booklet 200 can be a “Comprehension” page 150 (FIG. 6) that has a third tab 152 in a third location along the top edge 111 of page 150. The third tab 152 is of sufficient size to include the text “Comprehension” and be clearly visible to the user and protrude sufficiently such that the user can immediately access the page 150 by locating the third tab 152 and then opening the booklet 100 to the third tab page location. Below the third tab 152, the page 150 is an area 155 for testing the reading comprehension of the reader with respect to the reading passage 110 that was previously read. The reader is asked a series of questions and there are spaces for the reader to write answers. For example, one section asks the reader to write down what he or she thought was the main purpose of the author. Another section asks “What are four things the Carver made with Peanuts?” And yet another section asks “Why did people call Carver “The Farmer's Best Friend?”

Yet another of the subsequent pages can be an “Analyze” page 160 (FIG. 6) that has a fourth tab 162 in a fourth location along the top edge 111 of page 160. The fourth tab 162 is of sufficient size to include the text “Analyze” and be clearly visible to the user and protrude sufficiently such that the user can immediately access the page 160 by locating the fourth tab 162 and then opening the booklet 100 to the fourth tab page location. Below the fourth tab 162, the page 160 has a first area 165 in which questions are asked to the reader. In the illustrated embodiment, the reader is asked “In your opinion, what are some personality traits that Carver possessed?” and then is instructed to “Choose two traits and support your opinions with evidence from the text.”

The first, second, third and fourth tabs 132, 142, 152, 162 are at least partially laterally offset from one another so as to extend across the top edge of the booklet 100 and permit the reader to easily locate and go to a specific page of interest.

As can be seen in FIGS. 5-6, the individual pages 130, 140, 150, 160 can be arranged as part of the base booklet 200 with two individual pages 130, 140, 150, 160 being presented on a single page of the base booklet 200. Dotted lines 214 are included to guide the user in cutting out the individual pages from the base booklet 200 to construct the tab booklet 100.

The width of the individual pages 130, 140, 150, 160 is equal to the width of the bottom portion of the reading passage page 110 which includes the tab 120 such that when all of the pages of the booklet 100 are combined and overlaid one another, the booklet 100 has at least approximately uniform edges. As with most booklets, the booklet 100 is left justified and a fastener, such as one or more staples, can be used along the left edges of the pages of the booklet 100 to attach the individual pages to one another. Each fastener is preferably placed close to the left edges of the pages so as to not interfere with the written text/graphics on the individual pages.

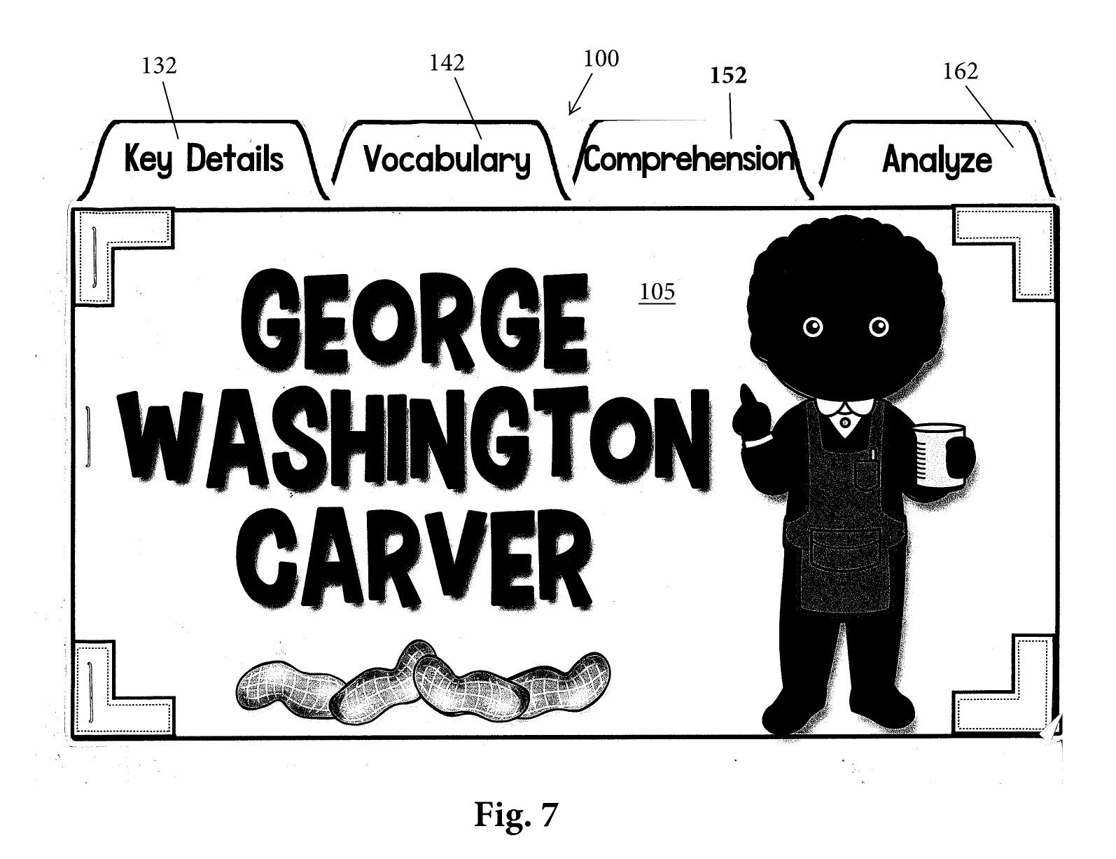

FIG. 7 shows the book 100 in its assembled position with the front cover 105 being displayed.

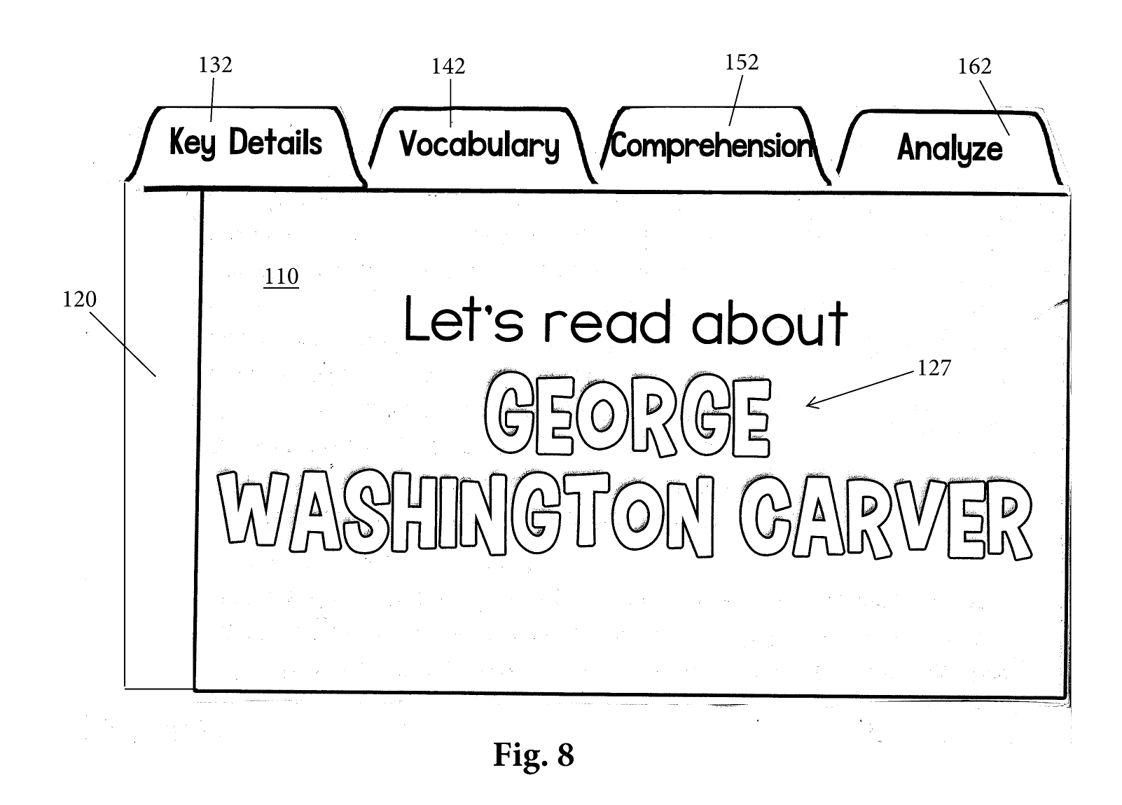

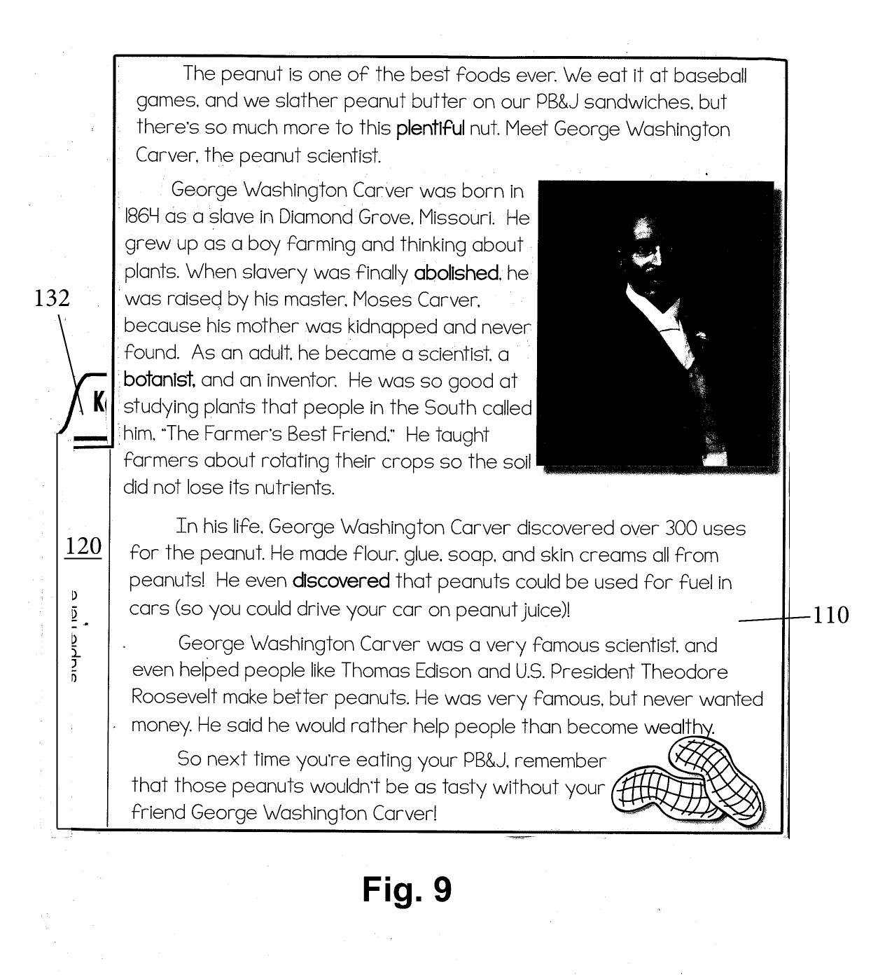

To construct the booklet 100, the reading passage page 110 is folded along a fold line 119 (FIG. 3) resulting in the top edge of the page 110 being aligned or closely aligned with the bottom edge of the page 110. The tab 120 thus extends along the left side of the folded page and provides a free area for the fastener to pass through to attach the pages. The fold line 119 is also located such that when the top half is folded over on top of the bottom half, the tabs 132, 142, 152, 162 are clearly visible and accessible across the top of the booklet 100. As shown in FIG. 8, the folding of the top half of the reading passage page 110 results in the text/graphics 127 on the rear surface of the reading passage page 110 being visible and representing the front face of the folded reading passage page 110. FIG. 9 shows the reading passage page 110 in an open position.

The cover sheet 105 (front page) of the booklet 100 is placed over the folded reading passage page 110 and other pages, such as tabbed pages 130, 140, 150, 160 are placed after the reading passage page 110. In addition, other pages, such as blank pages or lined pages, can be placed after the last tabbed page (e.g., page 160) and can be used for additional questions, additional research notes, or for paragraph writing.

It will therefore be appreciated that the use of the folded reading passage page 110 allows for content to be displayed to the user and in this case, allows the reader to read a passage concerning a topic/subject that is being presented to the reader. The left sided tab 120 of the reading passage page 110 allows for the folding of the main portion of the reading passage page 110 that contains the content (e.g., reading passage). The left sided tab 120 thus spaces the reading passage from the left side of the booklet 100 which contains the one or more fasteners and allows for the content of the reading passage page 110 to be more clearly viewed and allows the unfolding and refolding of the reading passage page 110.

The present invention is thus directed to a booklet construction and method for constructing a booklet that has both a tab feature and also a folded page as part of the booklet. The base booklet 200 from which the tab booklet 100 is created can also provide additional educational and fun commentary concerning the subject portrayed in the booklet 100. Thus, the user first has the fun task of constructing the tab booklet 100 from the base booklet 200 and then can enjoy reading and completing the exercises presented in the tab booklet 100. As mentioned, the number of topics that can be presented in the booklet 100 is endless, from history to sports to travel to geography, etc.

1. A booklet comprising:
a cover;
a reading passage page that has a first portion in which first content is contained and a side tab that extends outwardly along a first side edge, the reading passage page including a single fold line that defines a top portion and a bottom portion of the reading passage page; and
a plurality of tabbed pages located subsequent to the reading passage page, each tabbed page including a tab formed along a top edge of the tabbed page, wherein the tabs of the tabbed pages are laterally offset from one another;
wherein the fold line is located such that when the top portion is folded along the fold line and is superimposed over the bottom portion, the tabs are visible and extend above the folded reading passage page and the fold line aligns with a top edge of the booklet defined at least by a top edge of the cover;
wherein the booklet is fastened along a left side edge of the cover and the left side edges of the tabbed pages and along a left side edge of the tab portion.

2. The booklet of claim 1, wherein each tabbed page includes a first section in which second content is located and the tab is formed along a top edge of the first section.

3. The booklet of claim 2, wherein an area of the first section of each tabbed page is approximately equal to an area of each of the top portion and bottom portion of the reading passage page.

4. The booklet of claim 2, wherein a height of the side tab of the reading passage page is about equal to a height of the first section of the tabbed page.

5. The booklet of claim 1, wherein the first portion of the reading passage page includes a front face and an opposing rear face, the first content being presented on the front face.

6. The booklet of claim 5, wherein a top portion of the rear face of the reading passage page includes third content that is written upside down to allow the third content to be read in a left-to-right manner when the reading passage page is folded along the fold line.

7. The booklet of claim 1, wherein the fastener comprises a plurality of staples.

8. A method of constructing a tab booklet from a base booklet comprising the steps of:
cutting a cover page from a first page of the base booklet;
cutting a reading passage page from a second page of the base booklet, the reading passage page having a first portion in which first content is contained and a side tab that extends outwardly along a first side edge, the reading passage page including a fold line that defines a top portion and a bottom portion of the reading passage page;
folding the reading passage page once along the fold line so as to superimpose the top portion over the bottom portion such that the fold line aligns with a top edge of the cover page;
cutting a plurality of tabbed pages from a third page of the base booklet, each tabbed page including a tab formed along a top edge of the tabbed page;
aligning a left edge of the side tab with left edges of the cover page and left edges of the tabbed pages; and
inserting a fastener along the left edges of the cover page and tabbed pages and within the side tab of the reading passage page.
